(19) United States
(12) Patent Application Publication
(10) Pub. No.: US 2017/0238066 A1
(43) Pub. Date: Aug. 17, 2017

(54) METHOD AND COMPUTER PROGRAM PRODUCT FOR SELECTIVELY DISPLAYING ADVERTISMENTS DURING MEDIA PLAYBACK

(71) Applicant: Lionell Aaron Peters, Erda, UT (US)

(72) Inventor: Lionell Aaron Peters, Erda, UT (US)

(21) Appl. No.: 15/043,325

(22) Filed: Feb. 12, 2016

(51) Int. Cl. H04N 21/81; H04N 21/442; H04N 21/258; G06Q 30/02; H04N 21/2387; H04N 21/61; H04N 21/435; H04N 21/8545; H04N 21/472

(52) U.S. Cl. CPC H04N 21/812; H04N 21/8545; H04N 21/44222; H04N 21/25883; H04N 21/47217; H04N 21/2387; H04N 21/6125; H04N 21/435; G06Q 30/0277; G06Q 30/0254; G06Q 30/0255

(57) ABSTRACT

A method and computer program product for creating an end media file and/or selectively displaying advertisements during playback of media. Beneficially, such a system, method, and computer program product would create unique interactive marketing capabilities for a media provider and enhance the media content viewing experience for a viewer. The viewer selects from an eclectic assortment of at least one advertisement content before or while viewing playback of a selected media content. The media provider can view and analyze at least one viewership data that is related to the viewer and the media content for marketing purposes.

### BACKGROUND

Field of the Invention

This invention relates to a method and computer program product for selectively displaying advertisements during playback of media, and more particularly relates to a method and computer program product that provides a more enjoyable viewing experience for a viewer pod media content and enhanced interactive marketing capabilities for a media provider by enabling a viewer to select from at least one advertisement content while viewing playback of media content that is provided by a media provider, and then enabling the media provider to analyze viewership data of the viewer.

Description of the Related Art

Typically, media content outlets and other displays to external sources of media content data allow viewers to choose and view one of a plurality of media content units (e.g. movies, television programs, etcetera). Viewers can search for media content by title or, in some instances, by other information. However, the title, for example, is often not representative of the subject matter of the video content unit. Consequently, if a viewer does not know the title of the media content, it may be problematic to find media content of interest.

It is known that a major source of revenue for social media sites and commercial television broadcasters is the sale of broadcast time to advertisers. Advertisers have typically attempted to maximize the return on their advertising investment by targeting specific viewer segments that are likely to be most receptive to the commercial message embodied in the advertisements. One of the most widespread and simplest ways of targeting viewers involves identifying what types of viewers are associated with specific television programs.

Another method of targeting specific viewing audiences involves selecting advertisements according to the demographics, geographical region, and interests of the potential consumers to which the advertisements are broadcast. Frequently, viewers in one local or regional area may be more likely to be receptive to an advertiser's message than viewers in a different area. Also, the viewers may desire to see a specific advertisement for a specific product, service, or advertisement provider. Accordingly, advertising success and the advertising revenues received by broadcasters are maximized when different advertisements may be broadcast to different viewers and their varied tastes and needs.

Generally, media content delivery and distribution networks have a large number of disparate viewers. In many situations, it is desirable that the preferences and behaviors of these disparate users be known to the operators of the network. Moreover, in cases where the users are subscribers or customers of the delivery network, revenue, profit, and subscriber retention/addition are also critical concerns, since these factors effectively keep the network operator (and to some degree content producers) commercially viable.

Thus, there exists a need for a method and computer program product that allows a viewer to select media content and at least one advertisement content while viewing the media content. In addition, there is a need to provide a back end that allows a media provider to record and analyze viewership data of the viewer for marketing purposes. These and other features may be provided by one or more embodiments of the present invention.

### SUMMARY

From the foregoing discussion, it should be apparent that a need exists for a method and computer program product for selectively displaying advertisements during playback of media content. Beneficially, such a method and computer program product works to create unique interactive marketing capabilities for a media provider and enhance the viewing experience of a viewer for the media content.

The present invention has been developed in response to the present state of the art, and in particular, in response to the problems and needs in the art that have not yet been fully solved by currently available advertising systems and methods. According, the present invention provides a computer readable storage medium tangibly embodying a program of machine-readable instructions executable by a digital processing apparatus, the program comprising operations for selectively displaying advertisements during playback of media, the operations comprising: provide, by a media provider, a plurality of end media content, the end media content configured to be interactive with a viewer; prompt the viewer to select at least one advertisement content, the at least one advertisement content configured to be viewable with the media content; select, by the viewer, the at least one advertisement content; view the end media content and the at least one advertisement content; record at least one viewership data about the viewer, the at least one viewership data comprising at least one of the following: information about the viewer, the selection of the at least one advertisement content, the selection of the media content, and the interactive events between the viewer and the media content; and analyze the at least one viewership data.

The computer readable storage medium may, further comprise a step of monitoring the selected media content and at least one advertisement content by the viewer. The media provider may comprise a social site. The media content may include at least one member selected from the group consisting of: a video, an image, a text, an audio signal, a tactile content, and a visual content.

The media content may be configured to be accessible to the viewer through at least one member selected from the group consisting of: an interactive format, an internet, a phone app, a virtual reality, a television network, YouTube®, and Hulu®.

The computer readable storage medium of claim Error! Reference source not found., wherein the at least one advertisement content comprises a commercial for a product or service.

The at least one viewership data may comprise a demographic of the viewer.

The computer readable storage medium of claim Error! Reference source not found., wherein the at least one viewership data comprises a duration of viewing the media content by the viewer. The at least one viewership data may comprise a number of impressions versus views by the viewer.

The at least one advertisement may be configured to selectively integrate into the media content. The computer readable storage medium may further comprise: receiving uploaded native compressed media into computer readable memory, the native compressed media comprising a plurality of interleaved content packets; receiving uploaded advertising compressed media into computer readable database memory, the advertising compressed media comprising a plurality of interleaved content packets, each advertising compressed media exclusively associated with an advertiser; receiving a digital signal from a viewer via a signal bearing medium comprising a viewer's selection of an advertiser; modifying the native compressed media to add one or more content packets from the advertising compressed media from a group of advertising compressed media exclusively associated with an advertiser; creating an end media file comprising the compressed media and the secondary interleaved content packets; storing the end media file in computer readable storage; and multiplexing the end media file with a plurality of other signals; transmitting the end media file to the viewer. The computer readable storage medium may further comprise an Internet, the Internet configured to operatively connect the media content to the media outlet.

A computer readable storage medium tangibly embodying a program of machine-readable instructions executable by a digital processing apparatus is also provided, the program comprising operations for selectively displaying advertisements during playback of media, the operations comprising: receiving uploaded native compressed media into computer readable memory, the native compressed media comprising a plurality of interleaved content packets; receiving uploaded advertising compressed media into computer readable database memory, the advertising compressed media comprising a plurality of interleaved content packets, each advertising compressed media exclusively associated with an advertiser; receiving a digital signal from a viewer via a signal bearing medium comprising a viewer's selection of an advertiser; modifying the native compressed media to add one or more content packets from the advertising compressed media from a group of advertising compressed media exclusively associated with an advertiser; creating an end media file comprising the compressed media and the secondary interleaved content packets; storing the end media file in computer readable storage; and multiplexing the end media file with a plurality of other signals; transmitting the end media file to the viewer.

The computer readable storage medium may further comprise displaying the end media and pausing the end media indefinitely until a viewer responds to an advertisement embodied by the advertising content packets.

The media content may comprise at least one member selected from the group consisting of: a video, an image, a text, an audio signal, a tactile content, and a visual content.

The media content may be configured to be accessible to the viewer through at least one member selected from the group consisting of: an interactive format, an internet, a phone app, a virtual reality, a television network, YouTube®, and Hulu®.

The at least one advertisement content may comprise a commercial for a product or service. The computer readable storage medium may further comprise storing viewership data in computer readable memory. The computer readable storage medium may further include a media outlet, the media outlet configured to display the media content.

A method for selectively displaying advertisements during playback of media, the method comprising: providing, by a media provider, a media content, the media content configured to be interactive with a viewer; selecting, by the viewer, the media content; prompt the viewer to select at least one advertisement content, the at least one advertisement content configured to be viewable with the media content; select, by the viewer, the at least one advertisement content; view the media content and the at least one advertisement content; monitor the selected media content and at least one advertisement content by the viewer; record at least one viewership data about the viewer, the at least one viewership data comprising at least one of the following: information about the viewer, the selection of the at least one advertisement content, the selection of the media content, and the interactive events between the viewer and the media content; and analyze the at least one viewership data.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is an entity-relationship diagram illustrating a data interconnection between a viewer and a media content provider for a media content containing at least one advertisement content, in accordance with the present invention;

FIG. 2 is a program flow chart of a method for selectively displaying advertisements during playback of media, in accordance with the present invention;

FIG. 3 is a diagram illustrating a media file and advertisement integration system that enables at least one advertisement content to be integrated into a media content, in accordance with the present invention;

FIG. 4 is an entity-relationship diagram illustrating inter alia data interconnection between a viewer and a media content provider for a media content containing at least one advertisement content, in accordance with the present invention;

FIG. 5 is an entity-relationship diagram illustrating the evolution of native media to end media in accordance with the present invention; and

FIG. 6 is a block diagram showing modules of a system for selectively displaying advertisements during media playback in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

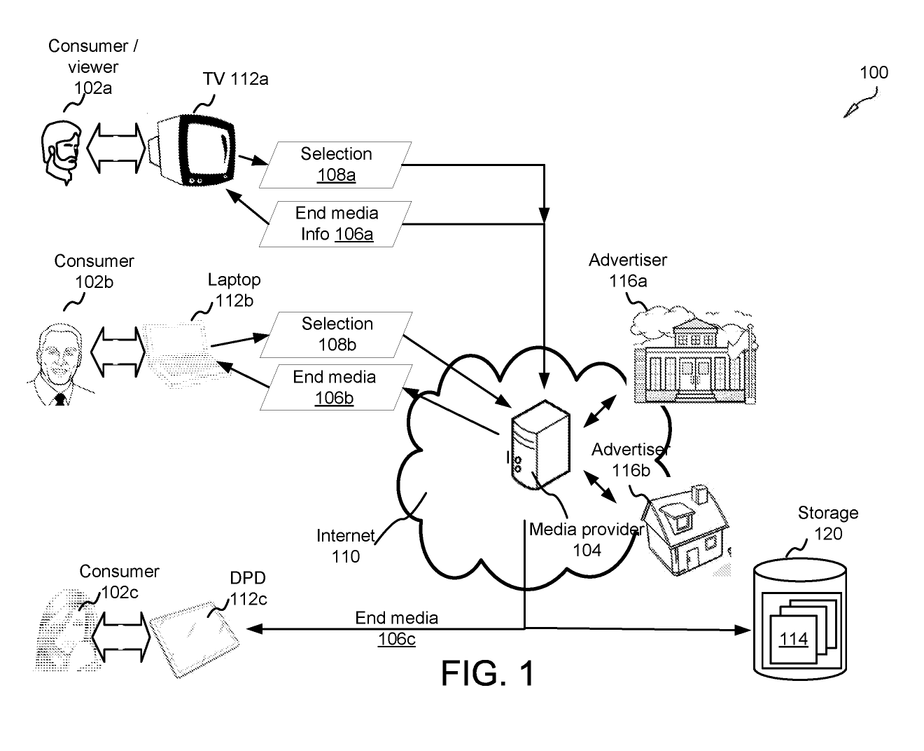

FIG. 1 is an entity-relationship diagram illustrates functions of a computer program product 100 for selectively displaying advertisements during playback of media. Beneficially, such a computer program product 100 would enhance a media content 106 viewing experience for a viewer 102, and create unique interactive marketing capabilities for a media provider 104.

The present invention has been developed in response to the present state of the art, and in particular, in response to the problems and needs in the art that have not yet been fully solved by currently available advertising systems and methods. In one embodiment, the computer program product 100 enables a viewer 102 to select from an eclectic assortment of at least one advertisement content 108a, 108b while viewing playback of a media content 106. Further, in one alternative embodiment, the viewer 102 may be prompted to select both the media content 106 and the advertisement content 108a-b. Though, the selection of media content 106 may be optional.

In some embodiments, the viewer 102 may include a potential consumer of a product or service. The media content 106 may include a video or movie that the viewer 102 has interest in viewing. The media provider 104 may include a marketing firm, a company, and a viewership ratings organization. In some embodiments, the media content 106 may be provided by the media provider 104 through a video, an image, a text, an audio signal, a tactile content, and a visual content. In other embodiments, the media content 106 may be accessed and viewed by the viewer 102 through interactive content, such as a social site.

In one exemplary embodiment, the computer program product 100 comprises a technological application that displays a multiple choice of video, text, visual, or audio advertisements that allow the viewer 102 to select at least one advertisement content 108a-b while viewing the selected media content 106.

The viewer 102 may receive the media content 106 through an interactive format, including, without limitation, an Internet 110, a phone app, a virtual reality content, a television network, YouTube™, and Hulu™. Further, the media content 106 may be viewed in various ways, including by: listening to streaming radio, reading a written content, interacting through a social media site, or any format in which advertisers or media provider 104s are present. In one possible embodiment, a media outlet 112, such as a television, computer screen, film room, or movie projector may be used to display the media content 106 to the viewer 102.

In one possible embodiment, an Internet 110 may be used to link the media provider 104 to the media outlet 112. In one embodiment, the Internet 110 comprises a global system of interconnected mainframe, personal, and wireless computer networks that use an Internet 110 protocol suite (TCP/IP) to link the media provider 104 to the media outlet 112. Though in alternative embodiments, other networks may be used to dispense and consume the media content 106 and advertisement content.

In one embodiment, the viewer 102 may be prompted before the media content 106 commences to choose from at least one advertisement content. The advertisement content may include a commercial or other marketing tool known in the art. The advertisement content can be a product 100 or service which the viewer 102 has interest in viewing, or even interest in a certain company or advertisement provider. For example, if the viewer 102 is interested in a new model of vehicle, the viewer 102 may select a vehicle commercial that displays throughout the media content 106.

Those skilled in the art will recognize that most media content 106 derives revenuer from advertisements. Thus, the present invention enhances the viewing experience of the viewer 102 by allowing the viewer 102 to select the desired advertisement content.

The selected advertisement content integrates into the media content 106 for consumption by the viewer 102. In one embodiment, the advertisement content integrates through a video file stream. The advertisement content may be viewable throughout the duration of the media content 106. For example, the advertisement content may include a fifteen second commercial that plays in the beginning and in the middle of a movie.

In essence, the viewer 102 can select, through multiple choice, a series of media content 106. The media content 106 may be predetermined and populated by the media provider 104, and include such media content 106 as: as Pandora™ NBC™ YouTube®, and Facebook®. In this manner, the viewer 102 selects a preferred media content 106, which will have integrated therein, at least one advertisement content, which is also selected by the viewer 102.

Further, the computer program product 100 allows the media provider 104, or a company to analyze the viewer 102 and the selections of the viewer 102. This analysis is used to enhance future marketing and media content 106. In some embodiments, the media provider 104 may view and analyze at least one viewership data 114a-b that is related to the viewer 102 and the media content 106 for marketing purposes. The viewership data 114a-b is a scientific breakdown of the viewer 102 and the viewer's 102 media and advertising viewing habits. In essence, the back end of the computer program product 100 provides a unique function to the media provider 104 by reporting back to the media provider 104 about the viewer's 102 decisions. The reported information may include at least one viewership data 114a-b. In one alternative embodiment, the viewership data 114a-b may be accessed and analyzed by at least one of the following: a company, government organization, marketing firm, scientific experiment, and a telephone list selling firm.

The media outlet 104 comprises the front end logic necessary to receive and transmit bitstreams (i.e., datastreams). The media outlet 104 may include the software, firmware, and hardware necessary to receive and process video content, including buffers, data unloaders, video unloaders, and the like.

Those skilled in the art will recognize that the viewership data 114a, 114b is a scientific breakdown of the viewer 102 and the viewer's 102 media content and advertisement content selections. In one embodiment, the viewership data 114a-b includes the number of impressions versus views by the viewer 102. For example, the demographics of the viewer 102 and the type of selected advertisement content are recorded and mapped for further analysis. Thus, by targeting various demographics, the assembled statistical models provide a rendering of the audiences of any given show, network, and programming hour. The viewership data 114a-b may also include the number of impressions versus views by the viewer 102. This is especially useful for Internet 110 based media content 106.

The analysis may further include a documented investigation of a market that is used to inform a firm's planning activities, particularly around decisions of inventory, purchase, work force expansion/contraction, facility expansion, purchases of capital equipment, promotional activities, and many other aspects of a company. Thus, the viewership data 114a-b of the viewer 102 based on the selected media content 106 and advertisement content forms the foundation for this analysis.

Accordingly, the present invention has been developed to provide a computer program product 100 for selectively displaying advertisements during playback of media content 106 that overcomes many or all of the above-discussed shortcomings in the art.

The present invention is also presented for selectively displaying advertisements during playback of media. The method 200 in the disclosed embodiments substantially includes the steps necessary to carry out the functions presented above with respect to the operation of the described system and computer program product 100.

In various embodiments of the present invention, media 106 may be streamed to data processing devices (DPDs) including tablet computers 112c, smart phones, televisions 112a, laptops 112b, and the like. The media 106 may be streamlined to one DPD after a selection 108 is made by a consumer 102 on an earlier DPD in response to an earlier prompt of the computer program product 100.

Native media (media uploaded by copyright owners for streaming to consumers 102) is stored in computer readable format 114.

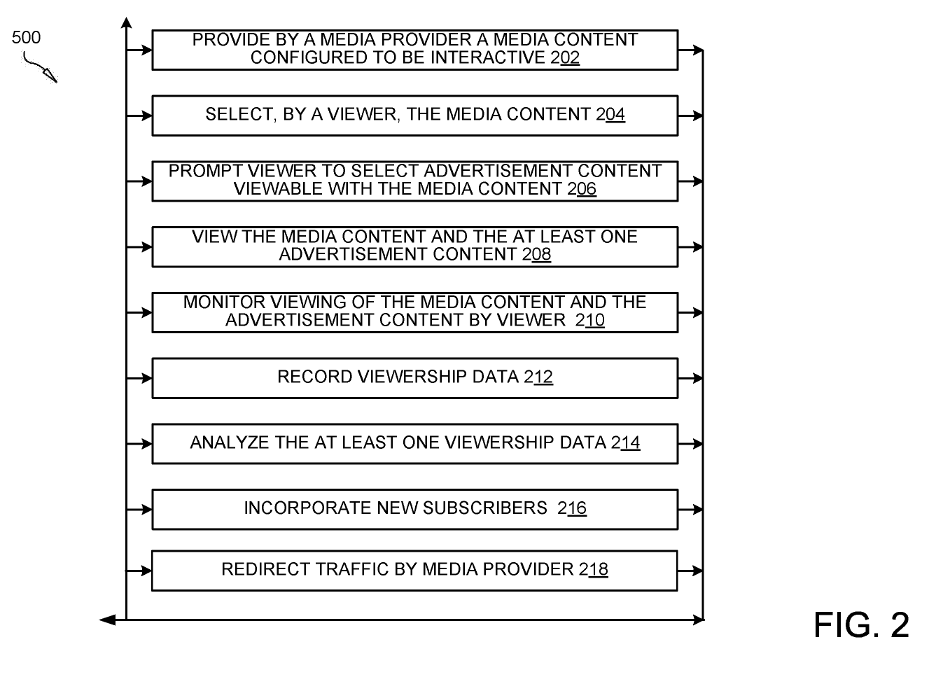

FIG. 2 illustrates a flowchart diagram of an exemplary method 200 for selectively displaying advertisements during playback of media. In one embodiment, the method 200 includes an initial Step 202 of providing, by a media provider 104, a media content 106, the media content 106 configured to be interactive with a viewer 102. The media content 106 may include a video, text, or other media consumable product 100 of interest to the viewer 102. Further, in one alternative embodiment, the viewer 102 may also select the media content 106. Though the selection of media content 106 may be optional.

A Step 204 comprises selecting, by the viewer 102, the media content 106. The viewer 102 may utilize a multiple choice format to select the desired media content 106 for viewing.

The method 200 may further include a Step 206 of prompting the viewer 102 to select at least one advertisement content, the at least one advertisement content configured to be viewable with the media content 106. The advertisement content may be selected prior to the commencement of the media content 106.

A Step 208 comprises selecting, by the viewer 102, the at least one advertisement content. The advertisement content may include a commercial or other marketing tool known in the art. The advertisement content can be a product 100 or service which the viewer 102 has interest in viewing, or even interest in a certain company or advertisement provider.

Another Step 210 includes viewing the media content 106 and the at least one advertisement content. Thus, the viewer 102 can enjoy both the media content 106 and learn about product 100s and services through the advertisement content.

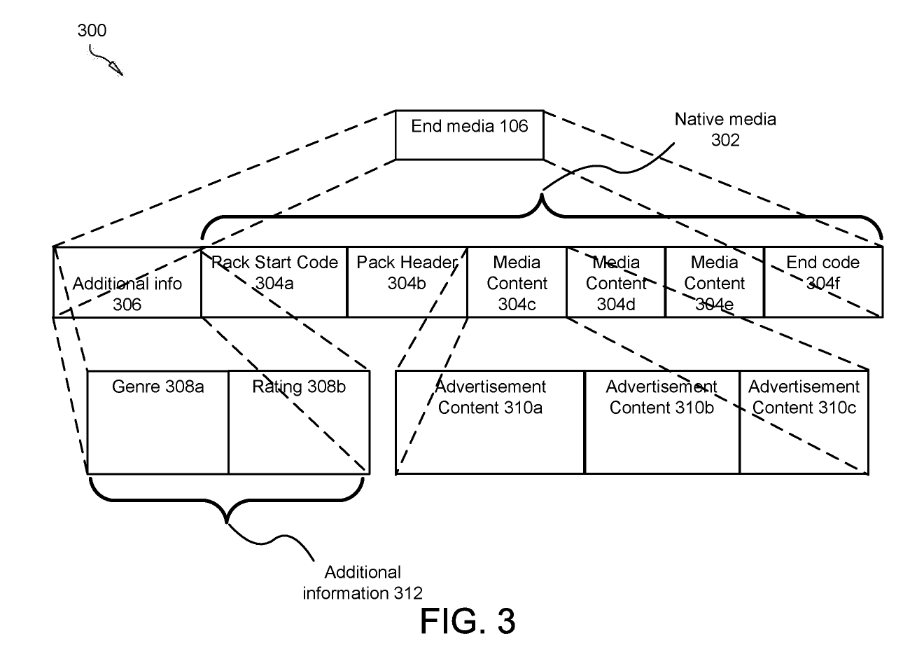

As FIG. 3 illustrates, an advertisement integration system 300 enables at least one advertisement content 310a-c to be integrated into end media 106. Though other means of displaying the media content 304a-f on a media content 312 are possible. In one embodiment. The at least one advertisement content 310a-c may plays throughout the duration of the end media 106 for viewing by the viewer 102 on a media outlet 312, or may play for only a portion of the duration of the media.

Continuing now with the steps of the method, a Step 212 comprises monitoring the viewing of the media content 106 and the at least one advertisement content 108a-b by the viewer 102. This allows for correct deduction of the selections and viewing habits of the viewer 102.

Yet another Step 214 may include recording at least one viewership data viewership data 114a-b about the viewer 102, the at least one viewership data 114a-b comprising at least one of the following: information about the viewer 102, the selection of the at least one advertisement content 108a-b, the selection of the media content 106, and the interactive events between the viewer and the media content 106. The viewership data 114a-b is a scientific breakdown of the viewer 102 and the viewer's viewing habits.

A final Step 216 comprises analyzing the at least one viewership data viewership data 114a-b. In one embodiment, this analysis comprises a study in the attractiveness and the dynamics of a special market within a special industry. The viewership data viewership data 114a-b of the viewer 102, which is based on the selected media content 106 and advertisement content 108a-b, forms the foundation for this analysis.

FIG. 3 illustrates the creation of an end media file 106.

The media outlet 104 is functionally capable of demultiplexing content units 304 such as MPEG compliant content units; analyzing the streams forming content units, such as elementary streams and program streams; and remultiplexing content units to include advertisements of third-parties, including advertisement 310a-c.

In various embodiments, the media outlet 104 may be in direct communication with the set-top boxes of televisions, which may perform the functions of the media outlet 104 after receiving content units rather than before the content units are transmitted from the media outlet 104.

The media outlet 104, or a system in logical communication with the media outlet 104, is configured, in certain embodiments, to process the content units as they become available in storage 114 to the media outlet 104 or a system or module in communication with it. The media outlet may processes these content units by demultiplexing packets within the content units, and adding advertisments based on viewer 102 selection. In the case of MPEG formatted content units (further described below), the audio and video portions of the content unit are interleaved together with audio and/or video from third-party advertisements into program streams 502. The program streams 502 contain packets linked together by standard tables built when the content unit was multiplexed by the media outlet 104 or another codec. In some embodiments, the program streams contain packets comprising advertisements.

In various embodiments, the native media 302 is reformatted so that audio and/or video data continues to run or stream behind an advertisement 310 inserted into the end media file 106. This puts pressure on a viewer 102 to quickly respond to an advertisement. In various embodiments, an advertisement responded to by a user opens a browser window which redirects the viewer 102 to an advertiser's 116 website.

The media outlet 104 creates an end media file which is stored in memory 114 in association with the content unit (i.e., native media) originating with copyright holders in a separate computer readable file in memory 114. The native media 302 provided to the media outlet 104 is demultiplexed, then remultiplexed with new media content units 304 comprising the advertisements of third-parties. This remultiplexed content is the end media file 106.

In certain embodiments, the media outlet 104 is further configured to store in memory the end media file 106 under the control of a DBMS or RDBMS like the database server 101.

The media outlet 104 and/or set topbox is configured to identify and store in volatile or nonvolatile memory the end media file 106, along with searchable incidental information such as Motion Picture Association of American (MPAA) rating information, availability dates of the content units, popularity information of the media and/or its included advertising, or even pricing information associated with the content units (the “additional information 312”). The additional information may comprise information about the genre of media featured in the content units, including movies, television programming, amateur home videos, closed-circuit video recordings, and the like.

In various embodiments, a viewer 102 search request may be static or dynamic. In various embodiments, the DBMS or RDBMS managing the content units reduces the search request to a query execution plan using hash tables and the like.

The end media 106 and/or content units may be broadcast and encoded in one of any number of various data encodings well-known to those of skill in the art created by various video compression codecs, such as H.261, Real Video and WMV.

The cable headend 112 comprises a master facility for receiving video content data for processing and distribution over a video content delivery system, such as a cable television system. The cable headend 112 may comprise all satellite and electronic equipment, systems, hardware, firmware, software, etcetera, necessary to receive and re-transmit content units 108 over the infrastructure in communication with the cable headend 112 for this purpose.

MPEG Data Encodings

MPEG codecs interleave packetized audio and video bitstreams, or elementary streams, into program streams created using standardized protocols to facilitate data transmission over one or more communication channel(s). Audio bitstreams are encoded to the MPEG standards in what has became known as the MPEG-1 Audio Layer 3 format, or MP3 format. MP3 codecs compress audio streams by reducing the accuracy of portions of the original audio stream considered to be beyond the auditory resolution ability of the average human ear.

In accordance with ISO Standard 11172, compressed MPEG media is comprised of layers of multiplexed information associated with, and forming, the compressed media (e.g. acoustic information is layered onto video information). In later versions of the MPEG standards, textual information, such as closed captions and even tactile information (e.g. Braille), are layered upon acoustic/audiographic and video information.

MPEG formatted media content, such as feature length films, are often stored in computer readable memory as encoded content units, which content units and transferred digitally from one data processing device (DPD) to another in the example embodiment. In various embodiments of the present invention, content units are modified to feature or comprise additional content information that accompanies the content units. Examples of this accompanying information, including various species of advertisements.

The set-top boxes comprise interactive devices that connect televisions and other displays to external sources of video content signals, such as the cable headend, in a manner that allows viewers 102 to receive end media 106. In some embodiments, the display may be a cathode ray tube (“CRT”), a liquid crystal display (“LCD”), a plasma display panel (“PDP”), or the like.

In the present invention, end media 106 may be received in response to request from the viewer 102 and a viewer 102 selection of one or more advertisers.

The end media 106 may be stored internal or external to the media outlet 104 and stored in a computer readable database controlled by the database server within or without the media outlet 104, such as IBM DB2, Oracle, or SQL. These database queries may be generated using various languages including SQL, XPATH, and the like, and may also comprise other identifiers relevant to creating, or identifying, the proper query execution plan such as the title and the names of speakers featured in the content units or other forms of additional information described above.

As shown in Figure three the additional information 312 may be added before the pack start code 304 (or after the pack start code 304). The native media 302 may comprise a pack header 304. Advertising content 310 is added to the native media 302, in some embodiments as a separate content unit 304.

In other embodiments, the native media 302 is paused and the advertising media played in its place from a separate computer readable file at randomly-spaced intervals.

The modified native media 302, containing the added advertisement content 310, becomes the end media 106 in some embodiments.

The content units are substantially described above in the relation to the other components of the dataflow interconnection.

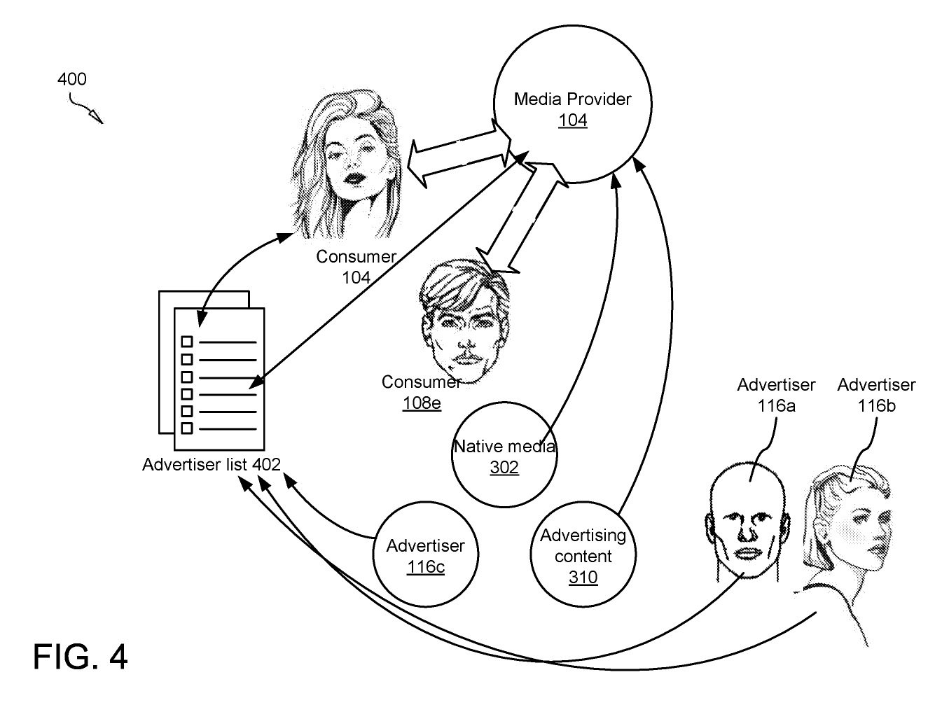

FIG. 4 is an entity-relationship diagram illustrating inter alia data interconnection between a viewer and a media content provider for a media content containing at least one advertisement content, in accordance with the present invention.

As shown, advertisers 116 are added to an advertiser list 402, which advertiser list is stored in computer readable memory 114. One or more advertisers are picked by a consumer from the list 402. Advertisers may be numbered in the listed by genre, size, price, or any other characteristic.

Native media 302 is uploaded or otherwise transmitted to a media provider 104. Advertising content 310 is also uploaded. The media provided combines the advertising content 310 and the native media 302 into a single computer readable file with the advertising media 310 spaced throughout the native media 302 at predetermined or random intervals.

In various embodiments, consumers are prompted either before or during media play to select an advertiser 116 from the advertiser list 402. The end

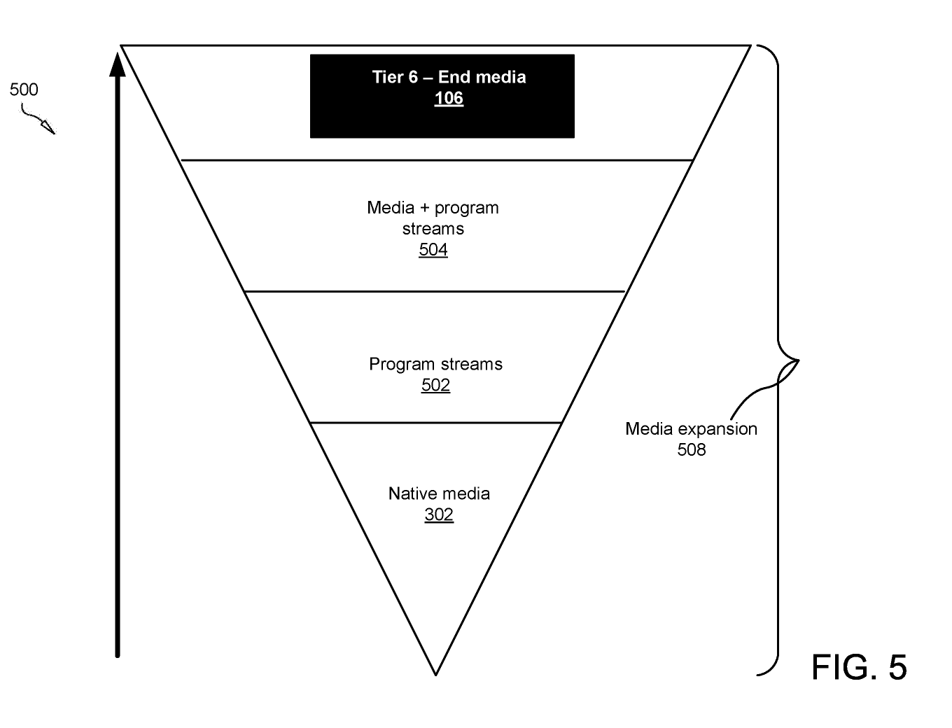

FIG. 5 is an entity-relationship diagram illustrating the evolution of native media to end media in accordance with the present invention. The native media file 302 is augmented with program streams 502, 504 from advertising 116. As the native media 302 is augmented, it grows in length eventually becoming the end media 106.

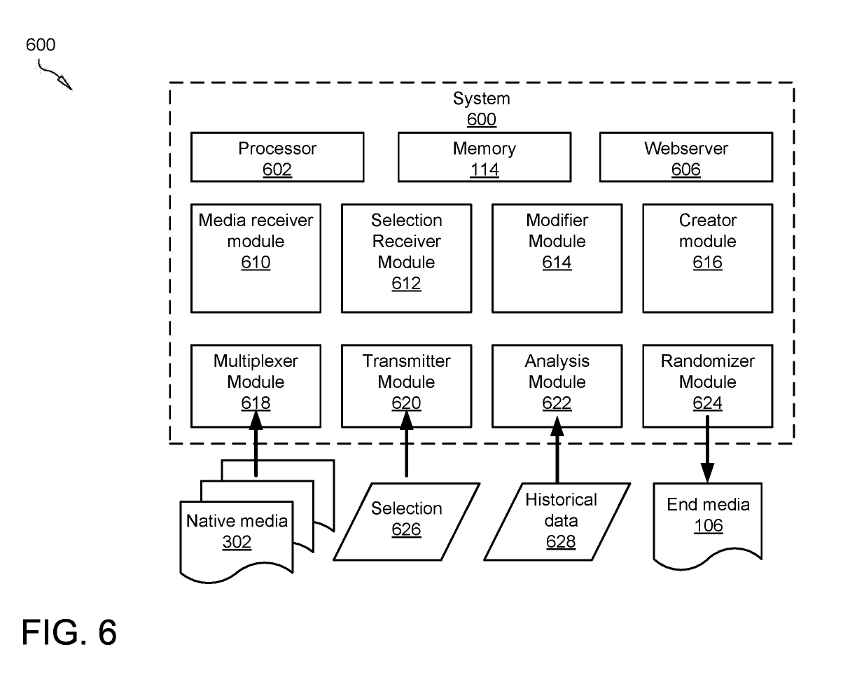

FIG. 6 is a block diagram showing modules of a system for selectively displaying advertisements during media playback in accordance with the present invention. The system 600 comprises a processor 602, memory 114, a webserver 606, a media receiver module 610, a selection receiver module 612, a modifier module 614, a creator module 616, a multiplexer module 618, a transmitter module 620 an analysis module 622, and a randomizer module 624.

The system 600 receives native media 302 from a copyright holder. In the preferred embodiment, the native media 302 is uploaded by the copyright holder, but may also be delivered manually or using other means known to those of skill in the art. The system 600 also receives a viewer 102 selection of an advertiser from whom to view advertisements during media playback. This selection may comprise a simple, single bit Boolean signal over a signal bearing medium or may comprise an integer, character string, file, or series of database files containing advertiser names or unique identifiers.

Historical data 628 is also uploaded into the system 600. This historical data may comprise information showing which advertisers a viewer 102 did not select from an advertiser list 402 that is either randomly populated, or populated with only advertisers satisfying a predetermined criteria, such as advertisers of a certain genre, doing business within a user-selected geographic area, advertisers below a certain price point, and the like.

End media 106, comprising the native media 302, is transmitted from the system 600 to the viewer 102.

The media receiver module 610 receives media from sources outside the system 600, including a copyright holder having the native media 302 and/or advertisers 116 uploading advertising media comprising commercial, hyperlinks, images, audio, text and the like.

The selection receiver module 612 receives the selection 626 from a viewer 102 and associated the viewer 102 with advertiser(s) from the advertising list 402.

The transmitter module transmits the end media 106 to a viewer 102, and the analysis module receives and analyzes historical data from the viewer 102, including impressions be click by the viewer 102 on advertisement hyperlinks in the end media 106. The randomizer module 624 randomly selects intervals throughout the native media 302 for inserting advertisements. The multiplexer module 618 multiplexes the end media 106 and/or media 302, media 310. The creator module 616 creates the end media 106 from the native media 302 and media 310.

In various embodiments, the viewer 102 is prompted and/or required to type or select a reason one or more advertisers 116 were not selected and this information originating with the viewer 102 is forwarded with the historical data 628 to the system 600.

In various embodiments, the media outlet 104 comprises a digital signal processor (DSP). In various embodiments, the media outlet 104 is under the control of a digital internet provider, such as Comcast®.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer readable storage medium tangibly embodying a program of machine-readable instructions executable by a digital processing apparatus, the program comprising operations for selectively displaying advertisements during playback of media, the operations comprising:
provide, by a media provider, a plurality of end media content, the end media content configured to be interactive with a viewer;
prompt the viewer to select at least one advertisement content, the at least one advertisement content configured to be viewable with the media content;
select, by the viewer, the at least one advertisement content;
view the end media content and the at least one advertisement content;
record at least one viewership data about the viewer, the at least one viewership data comprising at least one of the following: information about the viewer, the selection of the at least one advertisement content, the selection of the media content, and the interactive events between the viewer and the media content; and
analyze the at least one viewership data.

2. The computer readable storage medium of claim 1, further including a step of monitoring the selected media content and at least one advertisement content by the viewer.

3. The computer readable storage medium of claim 1, wherein the media provider comprises a social site.

4. The computer readable storage medium of claim 1, wherein the media content comprises at least one member selected from the group consisting of: a video, an image, a text, an audio signal, a tactile content, and a visual content.

5. The computer readable storage medium of claim 1, wherein the media content is configured to be accessible to the viewer through at least one member selected from the group consisting of: an interactive format, an internet, a phone app, a virtual reality, a television network, YouTube™, and Hulu™.

6. The computer readable storage medium of claim 1, wherein the at least one advertisement content comprises a commercial for a product or service.

7. The computer readable storage medium of claim 1, wherein the at least one viewership data comprises a demographic of the viewer.

8. The computer readable storage medium of claim 1, wherein the at least one viewership data comprises a duration of viewing the media content by the viewer.

9. The computer readable storage medium of claim 1, wherein the at least one viewership data comprises a number of impressions versus views by the viewer.

10. The computer readable storage medium of claim 1, wherein the at least one advertisement is configured to selectively integrate into the media content.

11. The computer readable storage medium of claim 1, further comprising:
receiving uploaded native compressed media into computer readable memory, the native compressed media comprising a plurality of interleaved content packets;
receiving uploaded advertising compressed media into computer readable database memory, the advertising compressed media comprising a plurality of interleaved content packets, each advertising compressed media exclusively associated with an advertiser;
receiving a digital signal from a viewer via a signal bearing medium comprising a viewer's selection of an advertiser;
modifying the native compressed media to add one or more content packets from the advertising compressed media from a group of advertising compressed media exclusively associated with an advertiser;
creating an end media file comprising the compressed media and the secondary interleaved content packets;
storing the end media file in computer readable storage; and
multiplexing the end media file with a plurality of other signals;
transmitting the end media file to the viewer.

12. The computer readable storage medium of claim 1, further including an Internet, the Internet configured to operatively connect the media content to the media outlet.

13. A computer readable storage medium tangibly embodying a program of machine-readable instructions executable by a digital processing apparatus, the program comprising operations for selectively displaying advertisements during playback of media, the operations comprising:
receiving uploaded native compressed media into computer readable memory, the native compressed media comprising a plurality of interleaved content packets;
receiving uploaded advertising compressed media into computer readable database memory, the advertising compressed media comprising a plurality of interleaved content packets, each advertising compressed media exclusively associated with an advertiser;
receiving a digital signal from a viewer via a signal bearing medium comprising a viewer's selection of an advertiser;
modifying the native compressed media to add one or more content packets from the advertising compressed media from a group of advertising compressed media exclusively associated with an advertiser;
creating an end media file comprising the compressed media and the secondary interleaved content packets;
storing the end media file in computer readable storage; and
multiplexing the end media file with a plurality of other signals;
transmitting the end media file to the viewer.

14. The computer readable storage medium of claim 13, further comprising displaying the end media and pausing the end media indefinitely until a viewer responds to an advertisement embodied by the advertising content packets.

15. The computer readable storage medium of claim 13, wherein the media content includes at least one member selected from the group consisting of: a video, an image, a text, an audio signal, a tactile content, and a visual content.

16. The computer readable storage medium of claim 13, wherein the media content is configured to be accessible to the viewer through at least one member selected from the group consisting of: an interactive format, an internet, a phone app, a virtual reality, a television network, YouTube®, and Hulu®.

17. The computer readable storage medium of claim 13, wherein the at least one advertisement content comprises a commercial for a product or service.

18. The computer readable storage medium of claim 13, further comprising storing viewership data in computer readable memory.

19. The computer readable storage medium of claim 13, further including a media outlet, the media outlet configured to display the media content.

20. A method for selectively displaying advertisements during playback of media, the method comprising:
providing, by a media provider, a media content, the media content configured to be interactive with a viewer;
selecting, by the viewer, the media content;
prompting the viewer to select at least one advertisement content, the at least one advertisement content configured to be viewable with the media content;
selecting, by the viewer, the at least one advertisement content;
viewing the media content and the at least one advertisement content;
